(19) United States
(12) Patent Application Publication
(10) Pub. No.: US 2026/0203931 A1
(43) Pub. Date: Jul. 16, 2026

(54) SYSTEM AND METHOD FOR PROVIDING NEUROMORPHIC AIRCRAFT STORES CENTRIC EXPENDABLE AND RETURNABLE NETWORKED TECHNOLOGY

(71) Applicant: JAIME AMERICA, LLC, Niceville, FL (US)

(72) Inventors: Malcolm Glenn Tutty, Campbell (AU); Andrew T. Cenko, Flagstaff, AZ (US)

(21) Appl. No.: 19/428,245

(22) Filed: Dec. 21, 2025

Related U.S. Application Data
(60) Provisional application No. 63/916,433, filed on Nov. 12, 2025.

(30) Foreign Application Priority Data
Dec. 22, 2024 (AU) 2024904274

(51) Int. Cl. G06T 7/70

(52) U.S. Cl. CPC G06T 7/70; G06T 2207/20084; G06T 2207/30252

(57) ABSTRACT

A system is disclosed providing for at least one neuromorphic imaging device affixed to at least one of a store and a vehicle to which the store is attachable, the at least one neuromorphic imaging device collects indicia indicating pixel position changes over a time period representing the store's position and a data processing system to determine at least one of separation and return parameters between the store and the vehicle based on information provided by the at least one neuromorphic imaging device and data provided about a least one of the store, the vehicle, a past data from at least one of deployment and return of the store, and at least one environmental condition. A method is also disclosed.

### CROSS-REFERENCE TO RELATED APPLICATIONS

This application claims the benefit of Australian Provisional Application No. 2024904274 filed Dec. 22, 2024, and claims benefit of U.S. Provisional Application No. 63/916433 filed Nov. 12, 2025, the entirety of which are incorporated by reference.

### BACKGROUND

Embodiments relate to deployment of objects from an aerial vehicle and, more specifically, to determining aircraft stores compatibility during safe separation from the aerial vehicle aircraft and if desired safe return of the aircraft store to the aerial vehicle.

An aircraft store is traditionally a device intended for internal or external carriage or mounted on an aircraft whether or not the item is intended to be separated in flight from the aircraft or the store separated. The device may be non-expendable (carriage only) or expendable (carriage and separation from the aircraft). Hence, though not limiting, the aircraft store may be any weapon or munition released or dropped by the aircraft and also may include non-expendable and expendable items such as gun pods, fuel tanks, and other carriage items. Such aircraft stores traditionally never return to the launching aircraft.

The term far-field refers to the distance of the aircraft store, after release from the aircraft into the free-stream flow, generally beyond the flow field effects of the aircraft, about 10 calibres of the store diameter following separation from the aircraft.

Such aircraft stores compatibility is achieved across a range of speeds, altitudes and dive angle operating envelopes using existing Fourth and Fifth Epoch (where “Epoch” is synonymous with “Generation” throughout this document) aircraft stores and armament technology, by high-ejection velocities from aircraft Suspension and Release Equipment (S&RE) units dating from the era of unguided “dumb” bombs needing to rapidly traverse the aircraft stores safely into the “far-field” and the free-stream air to improve accuracy and minimise impact dispersion. Such high ejection velocities from explosive ejector cartridges or pneumatics in the S&RE drive the need for greater weight and structures both in the aircraft and the stores to achieve service lives of 30-50 years and dependableness during the dramatic ejection from the aircraft. This has been and continues to be expensive given the poor accuracy and precision when compared to reliable guided weapons. Guided network-enabled weapons with bi-directional links and multi-mode seeker functions are increasingly inexpensive while still being exposed to 1960's era S&RE ejection environments with no control until the stores are away from the aircraft.

Today, Remotely Piloted Aircraft (RPA), loitering munitions and miniature stores using intelligent and autonomous systems are also now becoming prolific and are cost effective to be expended where both are attritable or, designed to be low-cost enough for a higher loss rate to be acceptable in combat, though not necessarily meant to be expendable, having service lives of approximately a dozen missions rather than 30 to 50 years or more of service. All such embodiments are still speed limited for carriage and employment compared to the fighters or bombers they intend to protect or cooperate with.

This is changing and the nature of the change is unknown. Aircraft stores compatibility initiatives over the last 40 years have meant that reliability of such systems is now greater than 97% which has led to joint fires applications (coordinated application of lethal and non-lethal weapon systems by two or more components to create a specific effect on a target in support of a common objective), “Danger Close” (friendly forces are within a risk zone of friendly fire, such as artillery or airstrikes) agreements for weapons employment being possible since 2010. RPAs and recent stores also typically need recharging and/or refueling to maximise endurance. Fifth and Sixth Epoch aircraft are also using Weapon Open System Architectures (WOSA) (modular weapon systems with standardized interfaces, allowing for components to be more easily added, upgraded, or replaced) such as the Universal Armament Interface (UAI) (a standardized system that allows for the seamless integration of weapons onto military aircraft and other platforms, regardless of the platform's specific software or the weapon's manufacturer) to achieve domain level integration (where domain level covers five domains, namely land, sea, air, space and cyberspace) removing proprietary functional level integration issues thereby enabling “Shoot Cues” to be more representative of the truth for the human in command and Tailored Yields, namely specific, customized, or efficient result produced by “this person in command,” to be used.

One device that is generally used to assist with release (to initiate the separation which includes both primary employment and emergency jettison modes of operations) of stores is a conventional imaging device or camera. Such a camera captures frames of an entire scene at predetermined frame rates. Traditionally, multiple high-speed film and video frame cameras from aircraft combined with photogrammetric analysis and instrumentation is currently used at varying levels of fidelity to determine the position and attitude of an aircraft store after separation from an aircraft and to confirm the reliability of safe arming devices and lanyards until the store is in the “far-field” during post-mission processing. Hence, the data output is generally a large amount of data as a stream of full frames are captured, as a non-limiting example. All prior art frame cameras were only affixed to the aircraft and never to the stores. One of the reasons for this arrangement is because of the expense and more importantly affixing to the stores may change operational features of the stores, such as, but not limited to, changing its aerodynamic features and it's operational representativeness.

Currently, the life, range, and endurance of the current aircraft and stores are not being optimised for the Stores Manufacture to Target or Disposal Sequence (MTDS) life. Store MTDS optimisation will be possible with environmental (temperature, aero-acoustic, and vibration for example) instrumentation integrated via the WOSA/UAI near real time.

Furthermore, current and prior aircraft stores compatibility is achieved across the range of speeds, altitude and dive angles operating envelope using existing Fourth and Fifth Epoch aircraft stores and armament technology by high-ejection velocities from aircraft S&RE dating from the era of unguided ‘dumb bombs’ needing to rapidly traverse the aircraft stores safely into the “far-field” and the free-stream air to improve accuracy and minimise impact dispersion. This has been and continues to be expensive in terms of cost, aircrew casualties and aircraft lost given the poor accuracy and precision when compared to reliable guided weapons.

Therefore, achieving safe and satisfactory carriage, separation, and/or return of novel aircraft stores with aerial vehicles, or even any armament carried and separated, and/or returned to any, land, maritime and/or space launch vehicle is critical to future air, land, sea and space power. A new approach is required now that new Fifth and Sixth Epoch aircraft and drones are integrated via WOSA/UAI and likely to be far more interoperable and “attritable” using guided aircraft stores almost exclusively to maximise effectiveness and precision and significantly reduce losses of aircrews and collateral damage. A new approach is desired that provides for lower ejection velocities during separation and, if required, return of the store.

### SUMMARY

Embodiments relate to a system and method for providing neuromorphic aircraft stores centric expendable and returnable networked technology. The system comprises at least one neuromorphic imaging device affixed to at least one of a store and a vehicle to which the store is attachable, the at least one neuromorphic imaging device collects indicia indicating pixel position changes over a time period representing the store's position. The system also comprises a data processing system to determine at least one of separation and return parameters between the store and the vehicle based on information provided by the at least one neuromorphic imaging device and data provided about a least one of the store, the vehicle, a past data from at least one of deployment and return of the store, and at least one environmental condition.

The method comprises collecting indicia with at least one neuromorphic imaging device affixed to at least one of a store and a vehicle to which the store is attachable, indicating pixel position changes over time to represent a position of the store. The method also comprises determining at least one of separation and return parameters between the store and the vehicle with a data processing system, based on information provided by the at least one neuromorphic imaging device and data provided about a least one of the store, the vehicle, a past data from at least one of deployment and return of the store, and at least one environmental condition. The method further comprises at least one of separating the store from the vehicle and returning the store to the vehicle based on output from the data processing system.

Another method for training a data processing system based on at least one of a neural network and artificial intelligence model using at least one of a theoretical model, wind tunnel data, simulated trajectories, and measured data is disclosed.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIGS. 1A-1B show a comparison between a prior art imaging frame camera and the data received from a neuromorphic event camera;

FIG. 2 shows an exemplary embodiment of a system;

FIG. 3 shows another exemplary embodiment of a system;

FIG. 4 shows another exemplary embodiment of a system;

FIG. 5 shows another exemplary embodiment of a system;

FIG. 6 shows a graph of operational area of employment (separation or return) of a store with respect to the carriage;

FIG. 7 shows a method of an exemplary embodiment of a method; and

FIG. 8 shows block diagram of an exemplary computer system; and

FIG. 9 shows an embodiment of an operational mission.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Embodiments disclosed herein relate to determining aircraft stores compatibility during the safe separation or subsequently safe return of store(s) or armament(s) from at least one of an aircraft, aerial, or launch vehicles which may also be physically located sub-surface, surface or in space. “Aircraft” is used in the examples for clarity but should be understood to encompass any appropriate launch or return vehicle. As further disclosed herein, the method and system utilizes a neuromorphic event cameras or imaging device, separately or in conjunction with other instrumentation for additional data and to act as an independent safety-critical second input. Such event cameras and instrumentation provide a digital history of the trajectory for data processing to guide the stores'control surfaces and to provide environmental data for optimising network-enabled stores available safe life cycle during experimentations, test, training and operations. Furthermore, a neuromorphic imaging device essentially mimics the function of a human eye, only recording changes in light intensity at the pixel level, rather than capturing full frames at set intervals. The aircraft store(s) or armament(s) may be external or internal to the aircraft or launch vehicle, and may be launched independently of the return vehicle.

Using embodiments disclosed herein provide for stores with neuromorphic event camera and instrumentation, separately or in conjunction with other instrumentation, will enable Fifth and Sixth Epoch aircraft and launch vehicles to safely separate the next generation of expendable and returnable stores and armament, to optimise the life of both the aircraft and increasingly expensive multi-mode network-enabled guided stores and reduce the potential for crew loss and collateral damage.

The term camera and imaging device is used herein. These terms are meant to teach an event camera, also known as a neuromorphic camera. The neuromorphic camera is known to have a silicon retina or dynamic vision sensor provided as an imaging sensor that responds to local changes in brightness. Event cameras do not capture images using a shutter as conventional (frame) cameras do. Instead, each pixel inside an event camera operates independently and asynchronously, reporting changes in brightness as they occur, and staying silent otherwise. Event camera pixels generally independently respond to changes in brightness as they occur. Each pixel stores a reference brightness level and continuously compares it to the current brightness level. If the difference in brightness exceeds a threshold, that pixel resets its reference level and generates an event: a discrete packet that contains the pixel address and timestamp. Events may also contain the polarity (increase or decrease) of a brightness change, or an instantaneous measurement of the illumination level, depending on the specific sensor model. Thus, event cameras output an asynchronous stream of events triggered by changes in scene illumination. Furthermore, event cameras typically report timestamps with a microsecond temporal resolution, 120 dB dynamic range, and less under/overexposure and motion blur than frame cameras. This allows them to track object and camera movement (optical flow) more accurately.

Also, as used herein, the term “store” is not intended to be limiting to prior art stores. Non-limiting examples of a store includes an expendable store which generally separates from the aircraft in flight such as a missile, rocket, bomb, nuclear weapon, mine, torpedo, drone/RPA/satellite, pyrotechnic device, sonobuoy, signal underwater sound device, gun ammunition or other similar items. This category includes unguided and guided expendable stores that may be employed or jettisoned during flight prior to land and/or maritime entry and/or exit. A nonexpendable store includes a store that is not normally separated from the aircraft in flight such as a tank (fuel and spray), line-source disseminator, pod (refueling, thrust augmentation, gun, electronic attack, data link, etc.), multiple rack, target, cargo drop container, drone, or other similar items. A returnable store includes a store that is generally separated from the aircraft in flight such as a guided expendable store and is intended for land/maritime entry and/or exit, return to the aircraft S&RE or cargo bay/hold or other similar items as part of the mission. This would enable resupply and/or in the case of re-use the replenishment of the returnable stores expendables/fuel/mission programming for further use during the sortie/mission. This category also includes compatible expendable stores drones/RPA separated from other aircraft or independent launch mechanisms also ‘returning’ to the aircraft.

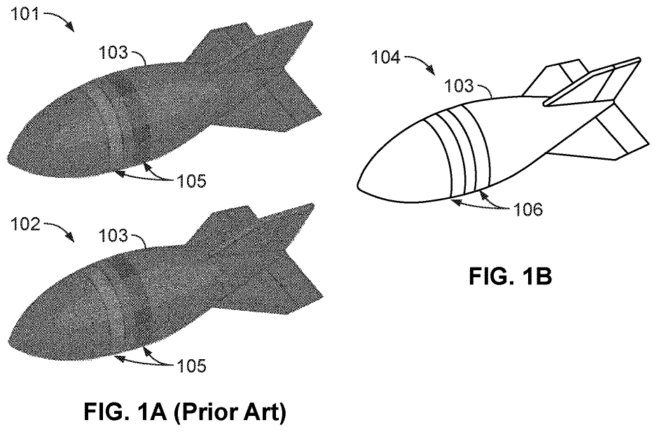

FIGS. 1A and 1B show a comparison between data received from a prior art imaging camera and from a neuromorphic event camera. FIG. 1A is a representation of an image from a prior art imaging device. FIG. 1B is a representation of all the individual events reported from a neuromorphic event camera or event camera within the time between frames 101 and 102. As shown with respect to the traditional camera, FIG. 1A, two sequential simulated image frames from a traditional camera, 101 and 102 are provided. The store 103 in these image frames is evaluated based on the stripes 105.

As shown with respect to FIG. 1B, the location or placement of the store 103 is determined by shifted pixels where the shift, though difficult to discern by human inspection, thickness of the store 103 represents an amount of movement. The neuromorphic event camera may provide a timestamped sequence of pixel positions experiencing intensity changes, with typically microsecond-level precision on the timestamps. As a non-limiting example, each measurement may comprise indicia, namely timestamp used to identify a change in intensity is detected, x-location of change, y-location or change, and brighter or darker indicated, such as, but not limited to, being identified by plus or minus one. To help visualize this, as shown in FIG. 1B, intensity changes may be detected between as point cloud image 104 as opposed to image frames 101 and 102 as traditionally done. More specifically, as represented, the “lines” 106 in 104 are multiple x/y positions of reported events. The clear or white areas are not reported by the event camera. Each change shown by the point cloud markings 106 may be reported separately, with a timestamp precision and reporting rate much higher than that of the prior art, or any traditional camera. More specifically, as a non-limiting example, the event camera may have a temporal resolution of less than 100 microseconds, while maintaining a resolution of 1280×720 pixels and small form factor (less than ~1 cubic inch).

Despite the higher precision and reporting rate, the quantity of information to process is generally reduced. As a non-limiting example, the neuromorphic event camera is not continuously reporting data. Instead, the event camera needs to only report changes in image intensity. If nothing in the image changes, the data rate is zero. Furthermore, if there is a sufficiently busy scene, the data rate may exceed that of a normal, prior art, camera. The scene may be controlled to minimize detected changes by isolating what to detect, e.g., but not limited to, relatively uniform color from the airplane body and sky, primarily detecting moving edges, etc. Though the FIG. 1B is illustrative only, also of note, the markings on the store 103 show up clearly in the point cloud 106 while the otherwise uniform store coloration 105 in FIG. 1A, visible in image frames 101 and 102 does not—this will be relevant to discussions of markers and emitters below.

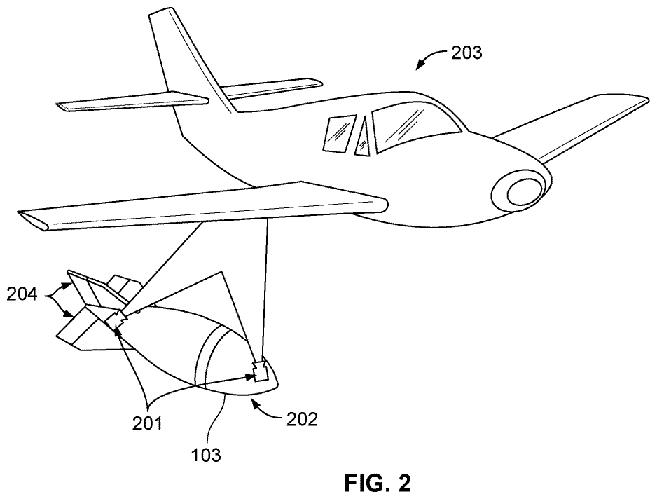

FIG. 2 shows an exemplary embodiment of the invention. At least one neuromorphic event camera 201 is mounted on a store 202 for monitoring a vehicle 203 that the store is either released from or is returning to. The store 202 may have one or more neuromorphic cameras 201, potentially along with other instrumentation (not shown), that allows for determining the store's orientation and position relative to the vehicle 203. Non-limiting examples of the instrumentation include, but are not limited to, accelerometer, gyroscope, magnetometer, GPS apparatus, traditional camera, etc. Though other instrumentation is discussed, in an embodiment only the event camera and accelerometer are required whereas the additional instrumentation may be used for MTDS and for reliability and redundancy. However, with the additional instrumentation when appropriately weighted, integrated and timed to work within mission and equipment parameters, the instrumentation may improve overall accuracy and precision. Though the accelerometer is mentioned above, the accelerometer may be required in practice, it is not required in theory. If regulations change, the accelerometer may be excluded.

At least one camera 201 needs to see the vehicle 203 for measurement of at least one of the relative position, orientation, motion, and acceleration between the store and vehicle, with additional event cameras 201 beyond the first event camera determining a larger effective field of view (e.g., monitoring the vehicle despite store rotation) and/or for more precise measurements (e.g., parallax). More specifically, by utilizing the embodiments disclosed herein, more capabilities over the prior art are available such as, but not limited to, measuring the position offset between two event cameras to determine a distance (parallax). Tracking this parallax change over time provides for a motion vector towards the event camera. Combining this with size changes in the image 104 improves the measurement quality. Multiple views also allow mitigation for noise, vibration, and similar effects that affect the store 103 and/or vehicle 203. Control surfaces 204 on the store 202 may allow the store 202 to maneuver based on these measurements.

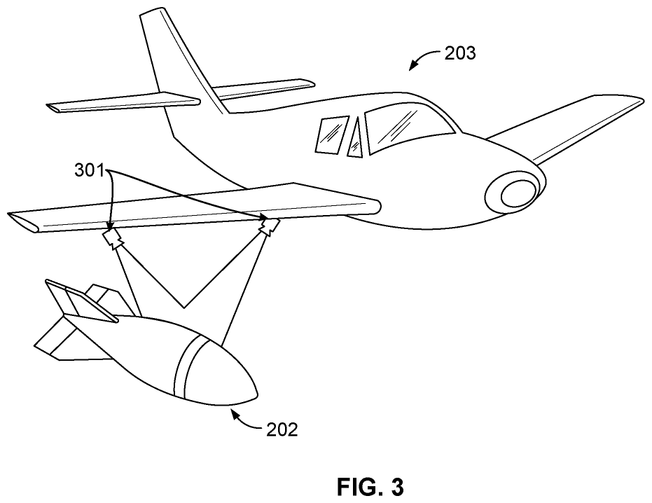

FIG. 3 shows another exemplary embodiment of the invention. Neuromorphic event cameras 301 are shown mounted on the releasing/returning aircraft 203 for monitoring the store 202. The vehicle 203 may have one or more neuromorphic cameras 301 mounted on the vehicle 203, potentially along with the other non-limiting instrumentation discussed herein. This arrangement is provided to determine the orientation and position of the vehicle 203 relative to the store 202. At least one camera 301 needs to see the store 202 for measurement of at least one of relative position, orientation, motion, and acceleration between the store 103 and vehicle 203. Additional cameras 301 beyond the first camera may provide for a larger effective field of view and/or for more precise measurements. The camera 301 on the vehicle 203 may be used independently or in addition to camera 201 on the store 202, with or without communication between the vehicle 203 and store 202.

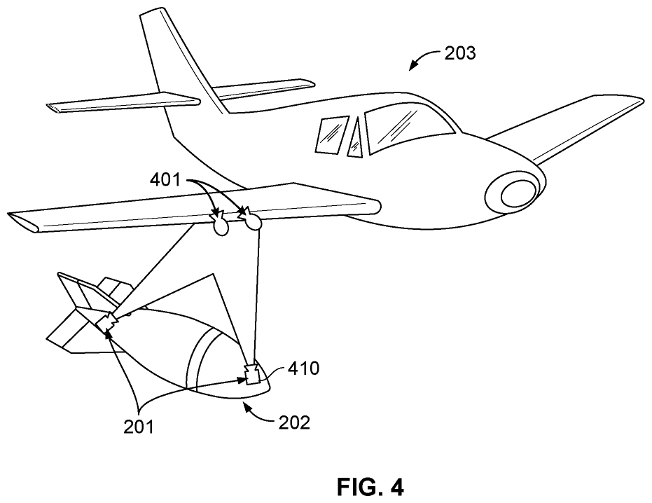

FIG. 4 shows another exemplary embodiment of the invention. FIG. 4 expands on FIG. 2, with one or more markers and/or emitters 401 on vehicle 203 in view of the cameras 201 on store 202. The marking(s) (or markers) and/or emitter(s) 401 may be sensed by the camera(s) 201 for improved measurement, as mentioned in the description of FIG. 1B, with marking(s)/emitter(s) 401 beyond the first marking/emitter allowing for a larger effective measurement range and/or for more precise measurements. The terms “marker,” “marking,” and “emitter” are provided not to be limiting. Non-limiting examples of these terms include fiduciary markers, photogrammetric markers, simple light source, colored light source, laser emitter, etc.

This system can particularly benefit from filtration by a filter 410 on the event camera 202 or in processing performed by a computing system or processor. More specifically, matching emission wavelength to a camera filter 410, or marking patterns simplifying unique identification in processing. Hence, the filter 410 may be matched to the marking/emitter. As a non-limiting example, the marking/emitter may only be visible in specific wavelengths of light. The event camera may be customized to perform using at least one optical filter 410 sensitive to the specific wavelengths of light of the marking/emitter.

As a non-limiting example, the physical filter 410 may be matched to the wavelength of the emitter light source which would reduce background noise. As another non-limiting example, a software filter may ignore any data that does not match the shape of a physical marker, wing edge, or similar (i.e., points have to match a certain shape within a certain amount of time or get thrown out).

While the markers and/or emitters 401 are shown on the vehicle 203, they may be placed anywhere practical (e.g., on pylons attached to the vehicle). As disclosed herein, the term marketing/markers or emitters illustrate that this element 401 may be passive in nature or active wherein an emitter signal is emitting from the element 401. Though those skilled in the art should understand, for clarification, passive means detection through reflected light (potentially light emitted by the measuring side, but also from sunlight or similar). Active would pertain to emitting light on its own. The event cameras 201 detect photons.

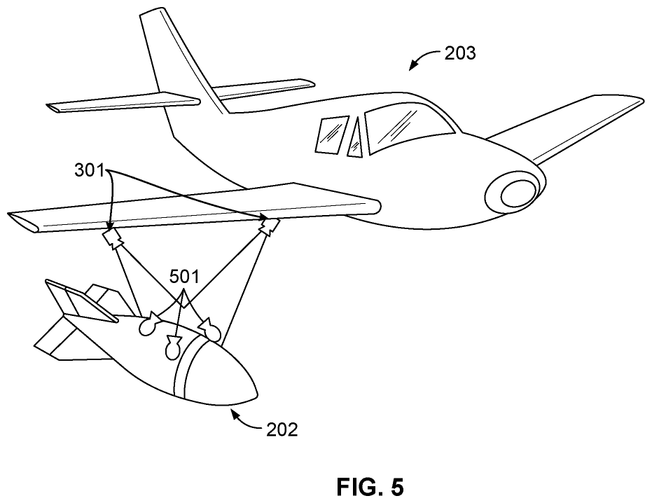

FIG. 5 shows another exemplary embodiment of the invention. FIG. 5 shows a more advanced embodiment with neuromorphic event cameras mounted on a releasing/returning aircraft monitoring the store with the aid of markers and/or emitters on the store. FIG. 5 expands on FIG. 3, with one or more markers and/or emitters 501 on the store 202 in view of the cameras 301 on vehicle 203. The marking(s) and/or emitter(s) 501 may be sensed by the camera(s) 301 for improved measurement, with marking(s)/emitter(s) 501 beyond the first marking/emitter 501 allowing for a larger effective measurement range and/or for more precise measurements. This benefits similarly from filtration as discussed with respect to FIG. 4 which may be used independently or in addition to sensors on the store as in the description of FIG. 3.

In any of the above described embodiments, by actively monitoring the relative orientation and position of the vehicle 203 and store 202, such monitoring may allow for stores with additional information, effectively providing for a smarter store, with lower ejection velocities, as well as guided separation and return phases if the store is to return to the vehicle 203. In addition to determining the relative orientation and position of the vehicle 203 and store 202, embodiments disclosed herein may measure vibration and temperature which may be used to conduct real time Manufacture to Target or Disposal Sequence (MTDS) life assessment.

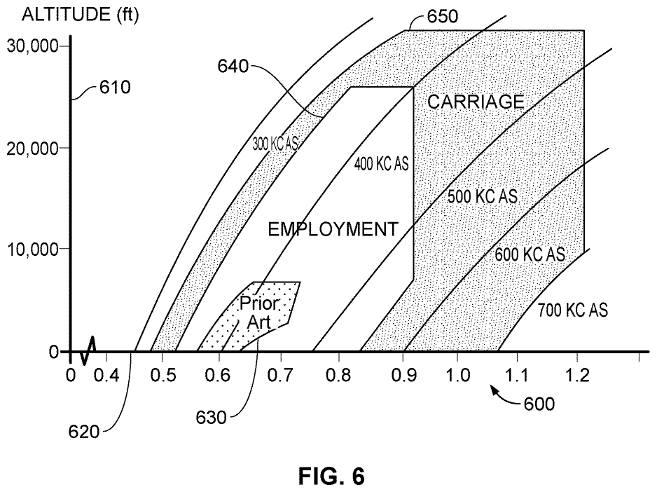

FIG. 6 shows a graph of operational area of employment (separation, jettison or return) of a store with respect to the carriage, for representational purposes only. As shown, the graph 600 is based on altitude 610 with respect to speed 620, in this representation Mach number. The graph 600 includes a prior art employment window 630, an employment window 640 utilizing embodiments disclosed herein and a carriage window 650. Utilizing the embodiments disclosed herein, the employment window 640 is more expansive than the prior art window, which provides for at least lower ejection velocities when compared to the prior art.

In the embodiments disclosed herein, the neuromorphic cameras 201, 301 essentially mimic human neural functions and eye functions, focusing on only important and significant changes to provide precise imagery. As a non-limiting example, they may leverage Physics-Informed Neural Networks (or PINNs) that may be trained to follow universal physical laws, ensuring adaptability across any aircraft platform. This may facilitate Real-Time Coordination by using a Neuromorphic architecture that integrates data from multiple sources, enabling rapid decision-making and coordination of distributed assets. By using the embodiments disclosed herein, enhanced stores and vehicle compatibility with respect to aerodynamic, structural, electrical and functional characteristics for flight and ground conditions are realized. Hence, the store 202 may be able to autonomously adjust its trajectory in real-time to avoid obstacles or recalibrate its mission parameters, which also allows for at least lower ejection velocities.

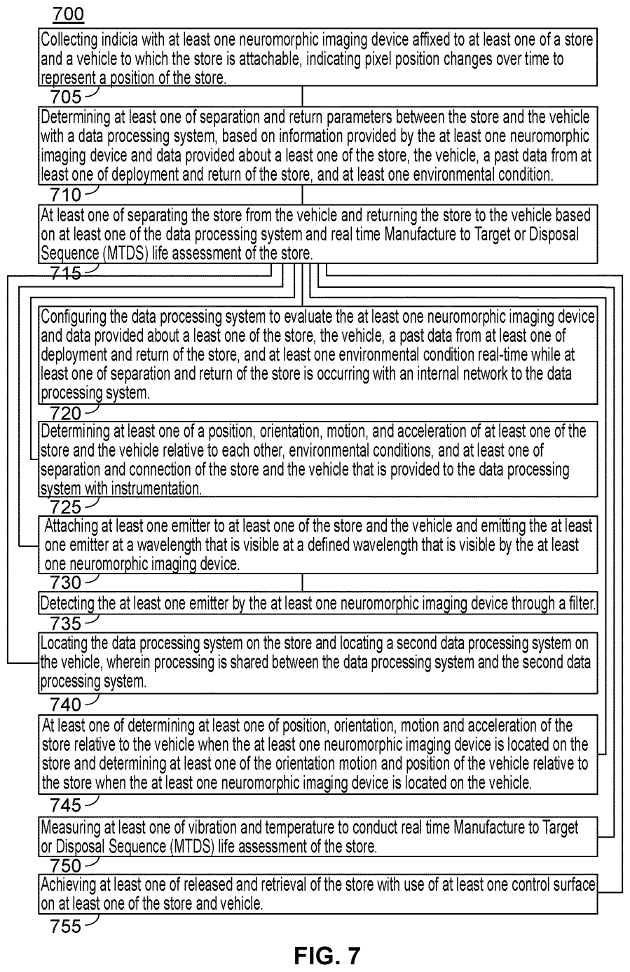

FIG. 7 shows an exemplary embodiment of a method. The method 700 comprises collecting indicia with at least one neuromorphic imaging device affixed to at least one of a store and a vehicle to which the store is attachable, indicating pixel position changes over time to represent a position of the store, at 705. The method 700 further comprises determining at least one of separation and return parameters between the store and the vehicle with a data processing system, based on information provided by the at least one neuromorphic imaging device and data provided about a least one of the store, the vehicle, a past data from at least one of employment and return of the store, and at least one environmental condition, at 710. The method further comprises at least one of separating the store from the vehicle and returning the store to the vehicle based on output from at least one of the data processing system and real time Manufacture to Target or Disposal Sequence (MTDS) life assessment of the store, at 715.

The method 700 may further comprise configuring the data processing system to evaluate the at least one neuromorphic imaging device and data provided about a least one of the store, the vehicle, a past data from at least one of deployment and return of the store, and at least one environmental condition real-time while at least one of separation and return of the store is occurring with an internal network to the data processing system, at 720. The method may further comprise determining at least one of an orientation position and motion of at least one of the store and the vehicle relative to each other, environmental conditions, and at least one of separation and connection of the store and the vehicle that is provided to the data processing system with instrumentation, at 725.

The method may further comprise attaching at least one emitter to at least one of the store and the vehicle and emitting the at least one emitter at a wavelength that is visible at a defined wavelength that is visible by the at least one neuromorphic imaging device, at 730.

The method may further comprise detecting the at least one emitter by the at least one neuromorphic imaging device through a filter, at 735. The filter may be at least one of an optical filter and a software based filter located within the data processing system.

The method may further comprise locating the data processing system on the store and locating a second data processing system on the vehicle, wherein processing may be shared between the data processing system and the second data processing system, at 740. The data processing system may be connected or in communication with an avionics system (not shown) on at least one of the vehicle 203 and the store 202. The method may further comprise at least one of determining at least one of position, orientation, motion, and acceleration of the store relative to the vehicle when the at least one neuromorphic imaging device is located on the store and determining at least one of the position, orientation, motion and acceleration of the vehicle relative to the store when the at least one neuromorphic imaging device is located on the vehicle, at 745.

The method 700 may further comprise measuring at least one of vibration and temperature to conduct real time MTDS life assessment of the store, at 750. The method may further comprise achieving at least one of release and retrieval of the store with use of at least one control surface on at least one of the store and the vehicle, at 755.

The processor of computer system is non-limiting. A key purpose of the computer system is to provide the capability for processing to occur from data received from the event camera to provide for lower ejection velocities during separation and return of the store to the vehicle or another vehicle. Thus, the computer system may be a trusted control system, such as, but not limited to an artificial intelligence component, an edge computing device, a neural network (such as, but not limited to, an artificial neural network, spiking neural network, etc.). The desire of the computer system is for it to closely mimic a human brain where intelligent agents are provided to perform complex tasks in real-time where physical knowledge of the environment, store, vehicle are embedded to assist in the training or learning of the computer system. As another non-limiting example, a physics informed neural network may be provided which integrates neuromorphic algorithms with the computer system.

As disclosed herein, another method of training a data processing system based on at least one of a neural network and artificial intelligence model using at least one of a theoretical model, wind tunnel data, simulated trajectories, and measured data is described. This method is specific to at least one of separation and retrieval of the store 202 to the vehicle 203.

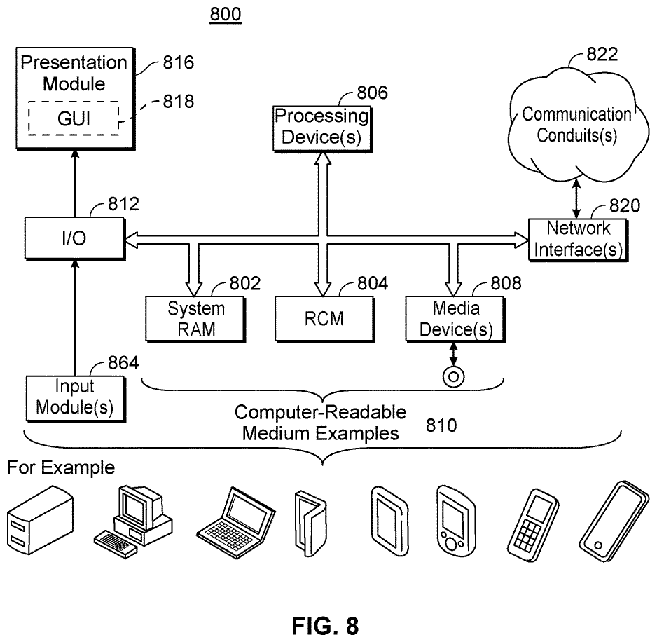

FIG. 8 shows block diagram of an exemplary computer system. A block diagram of an exemplary computer system, device, or computing functionality, 800 useful for implementing various aspects the processes disclosed herein, in accordance with one or more embodiments is shown. The computing device may be part hardware or equipment used to provide for the pattern to be moved cyclically in a constant and continuous pattern. In a basic configuration, a computing device 800 may include any type of stationary computing device or a mobile computing device. The computing device may be part of the additive manufacturing device as disclosed above. The computing device may include one or more processors 806 and system memory 810 in a hard drive, or media device, 808. Depending on the exact configuration and type of computing device, system memory 810 may be volatile (such as RAM), non-volatile (such as read only memory (ROM), flash memory, and the like) or some combination of the two. A system memory 810 may store an operating system, one or more applications, and may include program data for performing flight, navigation, avionics, power managements operations such as for space operations.

The computing device 800 may carry out one or more blocks of a process and/or the additive manufacturing processes described herein. The computing device may also have additional features or functionality. As a non-limiting example, the computing device may also include additional data storage devices (removable and/or non-removable) such as, for example, magnetic disks, optical disks, or tape. The computer storage media may include volatile and non-volatile, non-transitory, removable and non-removable media implemented in any method or technology for storage of data, such as computer readable instructions, data structures, program modules or other data. The system memory, removable storage and non-removable storage are all non-limiting examples of computer storage media. The computer storage media may include, but is not limited to, RAM, ROM, Electrically Erasable Read-Only Memory (EEPROM), flash memory or other memory technology, compact-disc-read-only memory (CD-ROM), digital versatile disks (DVD) or other optical storage, magnetic cassettes, magnetic tape, magnetic disk storage or other magnetic storage devices, or any other physical medium which can be used to store the desired data, and which can be accessed by computing device. Any such computer storage media may be part of device.

The computing device 800 may also include or have interfaces 812 for input device(s) (not shown) such as a keyboard, mouse, pen, voice input device, touch input device, etc. The computing device 800 may include or have interfaces for connection to output device(s) such as a display, speakers, etc. The computing device may include a peripheral bus for connecting to peripherals. The computing device 800 may also connect to a presentation module 816 and a graphical user interface 818. Computing device 800 may contain communication connection(s) 822 that allow the device to communicate with other computing devices, such as over a network or a wireless network via a network interface 820. By way of example, and not limitation, communication connection(s) may include wired media such as a wired network or direct-wired connection, and wireless media such as acoustic, radio frequency (RF), infrared and other wireless media. The computing device 800 may include a network interface card to connect (wired or wireless) to a network.

Computer program code for carrying out operations described above may be written in a variety of programming languages, including but not limited to a high-level programming language, such as C or C++, for development convenience. In addition, computer program code for carrying out operations of embodiments described herein may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed Digital Signal Processor (DSP) or microcontroller. A code in which a program of the embodiments is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD).

The embodiments may be configured for use in a computer or a data processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general-purpose computer, but rather the special purpose computer programmed to perform the disclosed algorithm.

A general-purpose computer, or microprocessor, may be programmed to carry out the algorithm/steps for creating a new machine. The general-purpose computer becomes a special purpose computer once it is programmed to perform particular functions pursuant to instructions from program software of the embodiments described herein. The instructions of the software program that carry out the algorithm/steps electrically change the general-purpose computer by creating electrical paths within the device. These electrical paths create a special purpose machine for carrying out particular algorithm/steps.

The processing system 800 may be located on at least one of the store 202 and the vehicle 203. Data on the processing system 800 may be shared to the other device (store or vehicle). The data processing system 800 may be on both the store 202 and the vehicle 203 where the data processing happens on both on-board the store 202 and vehicle 203. The store 202, vehicle 203, and other systems or instruments disclosed herein may share this information. Data processing may be enhanced by an Artificial Intelligence (AI) model. The AI model may be trained on data produced using physics-based modeling and simulation or prior data from prior missions, tests or simulations.

As disclosed herein, the vehicle 203 is non-limiting as the vehicle may be ground-based, sea-based, air-based, or space-based for launch and retrieval. As disclosed herein, specialized markings and/or emitters 401, 501 may be used on the store 202 and/or vehicle(s) 203 to assist in collecting data then used for processing the data.

The event camera 201, 301 or processing system 800 may be customized to only measure information from the specialized markings and/or emitters 401, 501. The markings and/or emitters 401, 501 where the markings and/or emitters are only visible in specific wavelengths of light. The markings and/or emitters 401, 501 may work in conjunction with other marketing and/or emitters to create a filterable signal for the event camera 201, 301 or processing system 800 to utilize as disclosed herein.

The method 700 disclosed herein may also be used to release and/or retrieve the store 202 from and/or to any compatible vehicle 203 or vehicles. The method 700 disclosed herein may use control surfaces 204 of the store 202 and/or vehicle 203 assist with the store release, land/maritime entry/exit and/or retrieval. The method 700 disclosed herein may measure vibration and temperature and conduct real time Manufacture to Target or Disposal Sequence (MTDS) life assessment. The method 700 disclosed herein may determine an assessment involving bi-directional data links during storage and on the vehicle carriage.

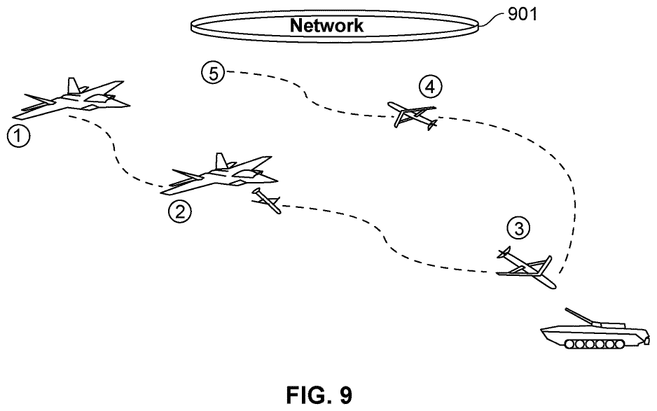

Thus, the embodiments above disclose expendable and/or returnable aircraft stores 202 and armaments (as used herein collectively identified as “store” or “stores”) that use neuromorphic event cameras 201, 301, separately or in conjunction with other instrumentation, gather data to achieve safe carriage, separation, and/or return using a change in the neuromorphic data as determined via a processing system 800 locate at least at one of the aircraft 203, store 202, and/or armament 202. The result is an ability to carry all categories of stores 202 where such measurements specific to vibration, temperature and conduct real time MTDS life assessment are provided via bi-directional data links during both storage and aircraft carriage. Another result is an ability to employ and guide the expendable and/or returnable store 202 to safely spatially position the store 202 relative to the employing vehicle 203, which may be the launch vehicle 203 or another vehicle, to achieve safe separation and then optimise the store's trajectory for the flyout and/or land/maritime entry/exit and/or return. Another result in use the store to enhance the “assess and abort” abilities of a lethal Autonomous Weapon Systems (AWS) during the Kill Chain (sequential attack steps—Find, Fix, Track, Target, Engage and Assess (F2T2EA)) Kill Web (resilient, interconnected network across domains (space, cyber, air) that links many kill chains allowing) to minimise collateral damage. “Kill Chain, Kill Web and AWS are terms those skilled in the art will readily recognize and understand. Yet another result is to guide and safely return the store to the employing, or other vehicle external S&RE or weapons/cargo bays S&RE for secure reprogramming, recharging, refueling, transiting, etc. FIG. 9 shows an embodiment of an operational mission using an embodiment disclosed herein. As shown at 1, a store is being carried by the launch vehicle 203 or aircraft. At 2, the store separates from the vehicle 203. At 3, the store performs its mission including conducting the Kill Chain with Enhanced Assess and Abort capabilities for lethal AWS and drones etc to minimize aircrew/aircraft and collateral damage. If the store is a type that is to return to a vehicle 203, the store then returns, at 4. The reason for returning is non-limiting, such as, but not limited to rearming, refueling, recharging, reprogramming, etc. At 5, using embodiments disclosed herein, the store is returned to a vehicle 203, which may be the same or different to the vehicle in 1. As further shown, a network 901 may be available as a communication system for communication amongst the vehicle 203 and/or the store 202 and at least one third party (not shown).

In view of the above disclosed embodiments, a system for determining the relative orientation, position, and motion of a store and vehicle using event/neuromorphic cameras, separately or in conjunction with other instrumentation, and data processing is disclosed. The system may further comprise where the data processing happens on board either the store 202 or the vehicle 203. The store 202 may share this information with the vehicle 203. In the prior art, the data processing occurred on the vehicle. The system may further comprise where the data processing happens both on board the store and vehicle. The system may further comprise where the processed information is shared between the store 202 and the vehicle 203. The system may further comprise where the vehicle 203 is an aircraft. The system may further comprise where the vehicle 203 is a ground-based, underwater or space-based launch or retrieval vehicle. The system may further comprise where specialized markings and/or emitters 401, 501 are used on the store 202 and/or vehicle(s) 203 to assist in processing the data. The system may further comprise where the event camera 201, 301 is customized to only measure information from the specialized markings and/or emitters 401, 501.

The markings and/or emitters 401, 501, as disclosed herein may only be visible on specific wavelengths of light. The event camera 201, 301 may be customized to perform using optical filters sensitive to the specific wavelengths of light. The markings and/or emitters may work in conjunction with emitters to create a filterable signal for the event camera.

A method 700 for determining the safe separation and/or return of the store 202 from or to the vehicle 203 or vehicles is disclosed above using the system as disclosed herein. The method 700 may be used to release and/or retrieve the store 202 from and/or to any compatible vehicle 203 or vehicles. The method 700 may be used where the control surfaces of the store 204 and/or vehicle 203 are used to achieve store release and/or retrieval.

Another method uses the system as disclosed herein to measure vibration and temperature and to conduct real time Manufacture to Target or Disposal Sequence (MTDS) life assessment. This method may use the system disclosed herein where the assessment involves bi-directional data links during both storage and vehicle carriage.

Unless otherwise defined, all terms (including technical and scientific terms) used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In particular, unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such data storage, transmission or display devices.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

We claim:

1. A system comprising:
at least one neuromorphic imaging device affixed to at least one of a store and a vehicle to which the store is attachable, the at least one neuromorphic imaging device collects indicia indicating pixel position changes over a time period representing the store's position; and
a data processing system to determine at least one of separation and return parameters between the store and the vehicle based on information provided by the at least one neuromorphic imaging device and data provided about at least one of the store, the vehicle, a past data from at least one of deployment and return of the store, and at least one environmental condition.

2. The system according to claim 1 wherein the data processing system comprises at least one of an internal network, neural network, and artificial intelligence model configured to evaluate the at least one neuromorphic imaging device and data provided about a least one of the store, the vehicle, a past data from at least one of deployment and return of the store, and at least one environmental condition real-time while at least one of separation and return of the store is occurring.

3. The system according to claim 1, further comprises instrumentation to determine at least one of an position, orientation, motion, and acceleration of at least one of the store and the vehicle relative to each other, environmental conditions, and at least one of separation and connection of the store and the vehicle that is provided to the data processing system.

4. The system according to claim 1, further comprises at least one emitter attached to at least one of the store and the vehicle.

5. The system according to claim 4, wherein the at least one emitter is visible at a defined wavelength that is visible by the at least one neuromorphic imaging device.

6. The system according to claim 5, wherein the at least one neuromorphic imaging device comprises a filter to detect the at least one emitter.

7. The system according to claim 6, wherein the filter is at least one of an optical filter and a software based filter located within the data processing system.

8. The system according to claim 1, wherein the vehicle is at least one of ground-based, sea-based, air-based, and space-based.

9. The system according to claim 1, further comprises a network connection to provide for communications between at least two of the store, vehicle, and a remote location.

10. The system according to claim 1, further comprises the data processing system located on the store and a second data processing system located on the vehicle, wherein information is shared between the data processing system and the second data processing system.

11. A method comprising:
collecting indicia with at least one neuromorphic imaging device affixed to at least one of a store and a vehicle to which the store is attachable, indicating pixel position changes over time to represent a position of the store;
determining at least one of separation and return parameters between the store and the vehicle with a data processing system, based on information provided by the at least one neuromorphic imaging device and data provided about at least one of the store, the vehicle, any past data from at least one of deployment and return of the store, and at least one environmental condition; and
at least one of separating the store from the vehicle and returning the store to the vehicle based on output from at least one of the data processing system and real time Manufacture to Target or Disposal Sequence (MTDS) life assessment of the store.

12. The method according to claim 11, further comprises configuring the data processing system to evaluate the at least one neuromorphic imaging device and data provided about a least one of the store, the vehicle, any past data from at least one of deployment and return of the store, and at least one environmental condition real-time while at least one of separation and return of the store is occurring with an internal network to the data processing system.

13. The method according to claim 11, further comprises determining at least one of a position, orientation, motion, and acceleration of at least one of the store and the vehicle relative to each other, environmental conditions, and at least one of separation and connection of the store and the vehicle that is provided to the data processing system with instrumentation.

14. The method according to claim 11, further comprises attaching at least one emitter to at least one of the store and the vehicle and emitting the at least one emitter at a wavelength that is visible at a defined wavelength that is visible by the at least one neuromorphic imaging device.

15. The method according to claim 14, further comprises detecting the at least one emitter by the at least one neuromorphic imaging device through a filter.

16. The method according to claim 15, wherein the filter is at least one of an optical filter and a software based filter located within the data processing system.

17. The method according to claim 11, further comprises locating the data processing system on the store and locating a second data processing system on the vehicle, wherein processing is shared between the data processing system and the second data processing system.

18. The method according to claim 11, further comprises at least one of determining at least one of position, orientation, motion and acceleration of the store relative to the vehicle when the at least one neuromorphic imaging device is located on the store and determining at least one of the orientation motion and position of the vehicle relative to the store when the at least one neuromorphic imaging device is located on the vehicle.

19. The method according to claim 11, further comprising measuring at least one of vibration and temperature to conduct real time MTDS life assessment of the store.

20. The method according to claim 11, further comprising achieving at least one of release and retrieval of the store with use of at least one control surface on at least one of the store and vehicle.

21. A method of training a data processing system based on at least one of a neural network and artificial intelligence model using at least one of a theoretical model, wind tunnel data, simulated trajectories, and measured data.
